(19) United States
(12) Patent Application Publication
(10) Pub. No.: US 2009/0185502 A1
(43) Pub. Date: Jul. 23, 2009

(54) Apparatus and method for planning a wireless network

(75) Inventors: Ki-Won Sung, Seoul (KR); Jim-Kyung Cha, Seoul (KR); Soo- Yeul Oh, Seoul (KR); Pyeong-Hwan Wee, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/321,405

(22) Filed: Jan. 21, 2009

(30) Foreign Application Priority Data
Jan. 22, 2008 (KR) 10-2008-0006646

(51) Int. Cl. H04W 16/00; G06F 11/30

(52) U.S. Cl. 370/252; 370/254

(57) ABSTRACT

An apparatus and method for planning a wireless network is provided. An apparatus for planning a wireless network includes a parameter input unit for receiving parameter information, and outputting the parameter information, a Rise over Thermal (RoT) calculator for calculating an RoT using the parameter information, and outputting the RoT, a first uplink performance prediction index determiner for determining a Modulation and Coding Scheme (MCS) level using the RoT, and outputting determined MCS level information, a maximum achievable Carrier to Interference and Noise Ratio (CINR) calculator for calculating a maximum achievable CINR of the determined MCS level using the determined MCS level information, and outputting a calculated maximum achievable CINR, and a second uplink performance prediction index determiner for determining at least one among a mobile station (MS) transmission power, a data rate, and an uplink CINR using the determined MCS level information.

### CROSS-REFERENCE TO RELATED APPLICATION(S) AND CLAIM OF PRIORITY

The present application claims the benefit under 35 U.S.C. § 119(a) of a Korean patent application filed in the Korean Intellectual Property Office on Jan. 22, 2008 and assigned Serial No. 10-2008-0006646, the entire disclosure of which is hereby incorporated by reference.

### TECHNICAL FIELD OF THE INVENTION

The present invention relates to an apparatus and method for planning a wireless network. More particularly, the present invention relates to an apparatus and method for planning a wireless network using a self configuration scheme.

### BACKGROUND OF THE INVENTION

Generally, there is a need for a method to predict a performance of a wireless network and optimize a wireless communication system based at least partly on the predicted performance in the wireless communication system. So, a wireless communication system, in a wireless network, should be able to predict an uplink performance and a downlink performance.

The wireless communication system should be able to calculate an uplink Carrier to Interference and Noise Ratio (CINR) to predict the uplink performance. And, the wireless communication system should be able to calculate a downlink CINR to predict the downlink performance.

The downlink CINR does not change according to a Modulation and Coding Scheme (MCS) level and data rate because a base station (BS) allocates the same transmission power to each subcarriers. So, the downlink CINR is easily to be determined by calculating a path loss between a BS and a mobile station (MS).

However, in the same region, the uplink CINR may vary in value because transmission power, which is allocated to each of uplink subcarriers, is varied due to a change in the transmission power of an MS (MS transmission power), an MCS level, and a data rate according to a scheduling state.

Therefore, it is difficult to accurately predict an uplink performance in a wireless network due to the described characteristic of the uplink.

### SUMMARY OF THE INVENTION

To address the above-discussed deficiencies of the prior art, it is a primary aspect of the present invention to address at least the above-mentioned problems and/or disadvantages and to provide at least the advantages described below.

Accordingly, an aspect of the present invention is to provide an apparatus and method for planning a wireless network using a self configuration scheme to accurately predict an uplink performance.

According to one aspect of the present invention, a method for planning a wireless network is provided. The method includes receiving parameter information, calculating a Rise over Thermal (RoT) using the received parameter information, determining a Modulation and Coding Scheme (MCS) level using the calculated RoT, calculating a maximum achievable Carrier to Interference and Noise Ratio (CINR) of the determined MCS level, and determining at least one among a mobile station (MS) transmission power, a data rate, and an uplink CINR using the determined MCS level and the calculated maximum achievable CINR.

According to another aspect of the present invention, a method for planning a wireless network by predicting an uplink performance of an arbitrary prediction point in the wireless network is provided. The method includes receiving performance prediction parameter information, selecting a Modulation and Coding Scheme (MCS) level which has the highest Modulation order Product coding Rate (MPR) among MCS levels supportable by the arbitrary prediction point, calculating a maximum Carrier to Interference and Noise Ratio (CINR) of the selected MCS level using the received performance prediction parameter information, determining a CINR of the arbitrary prediction point as one of the calculated maximum CINR and a required CINR of the selected MCS level when the calculated maximum CINR is greater than or equal to the required CINR of the selected MCS level, and predicting a transmission power and a data rate of the arbitrary prediction point using the determined CINR.

According to further another aspect of the present invention, an apparatus for planning a wireless network using a self configuration scheme is provided. The apparatus includes a path loss predictor for predicting a path loss between a base station (BS) and a mobile station (MS), and outputting a predicted path loss value, a downlink performance predictor for predicting a downlink performance using the predicted path loss value, and outputting a predicted downlink performance value, an uplink performance predictor for predicting an uplink performance using the predicted path loss value, and outputting a predicted uplink performance value, and a parameter determiner for setting at least one parameter necessary for planning a wireless network using a self configuration scheme using the predicted downlink performance value and the predicted uplink performance value, and determining a value of the set at least one parameter.

According to yet another aspect of the present invention, an apparatus for planning a wireless network is provided. The apparatus includes a parameter input unit for receiving parameter information, and outputting the parameter information, a Rise over Thermal (RoT) calculator for calculating an RoT using the parameter information, and outputting the RoT, a first uplink performance prediction index determiner for determining a Modulation and Coding Scheme (MCS) level using the RoT, and outputting determined MCS level information, a maximum achievable Carrier to Interference and Noise Ratio (CINR) calculator for calculating a maximum achievable CINR of the determined MCS level using the determined MCS level information, and outputting a calculated maximum achievable CINR, and a second uplink performance prediction index determiner for determining at least one among a mobile station (MS) transmission power, a data rate, and an uplink CINR using the determined MCS level information.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a structure of a self configuration apparatus according to an exemplary embodiment of the present invention;

FIG. 2 is a diagram illustrating a structure of a wireless network planning apparatus according to an exemplary embodiment of the present invention; and

FIG. 3 is a flow chart illustrating a process of determining an uplink performance prediction index of a wireless network planning apparatus according to an exemplary embodiment of the present invention.

Throughout the drawings, it should be noted that like reference numbers are used to depict the same or similar elements, features and structures.

### DETAILED DESCRIPTION OF THE INVENTION

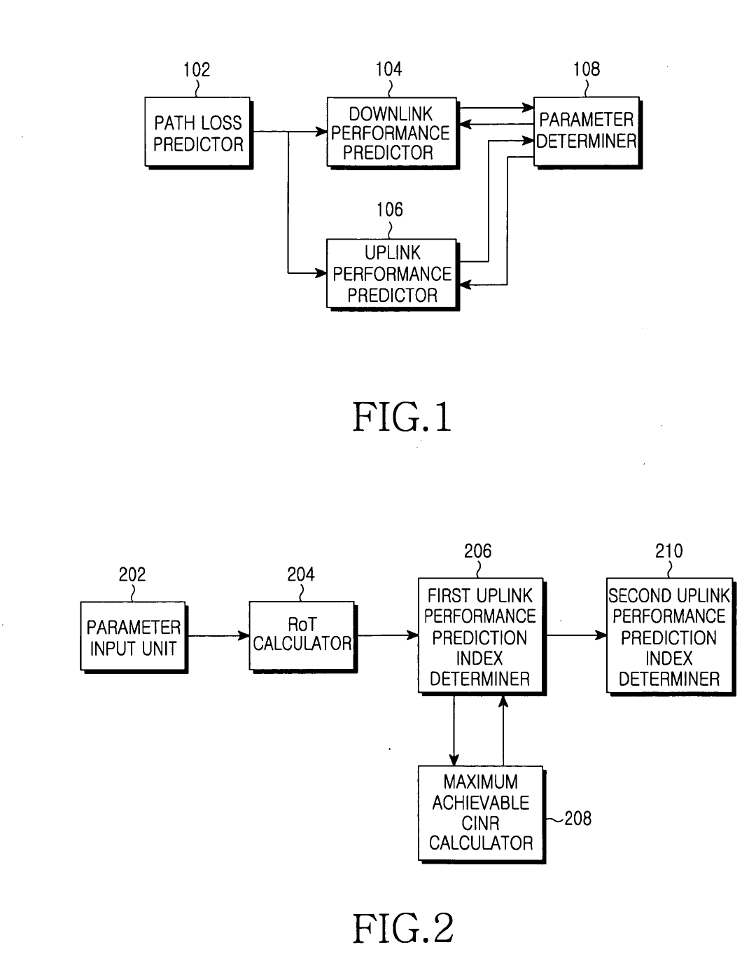

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provides an apparatus and method for planning a wireless network using a self configuration scheme and predicting an uplink performance accurately.

And, an apparatus and method for planning a wireless network according to exemplary embodiments of the present invention may be applied to a self configuration communication system which sets parameters used in the self configuration communication system by predicting an uplink performance and a downlink performance. An index representing the uplink performance and the downlink performance may include a received signal strength, a downlink Carrier to Interference and Noise Ratio (CINR), and an uplink CINR.

FIG. 1 is a diagram illustrating a structure of a self configuration apparatus according to an exemplary embodiment of the present invention.

Referring to FIG. 1, the self configuration apparatus includes a path loss predictor 102, a downlink performance predictor 104, an uplink performance predictor 106, and a parameter determiner 108.

The path loss predictor 102 predicts a path loss between a base station (BS) and a mobile station (MS), and outputs a predicted path loss value to the downlink performance predictor 104 and the uplink performance predictor 106.

The downlink performance predictor 104 and the uplink performance predictor 106 predict a downlink performance and an uplink performance, respectively, using the predicted path loss value output from the path loss predictor 102, and output a predicted downlink performance value and a predicted uplink performance value, respectively, to the parameter determiner 108.

The parameter determiner 108 sets parameters to be used in the BS using the predicted uplink performance value and the predicted downlink performance value, and determines values of the set parameters. In exemplary embodiments of the present invention, the parameters may include an uplink CINR, a Modulation and Coding Scheme (MCS) level, an MS transmission power, and a data rate. The parameter determiner 108 outputs the determined values of the set parameters to the downlink performance predictor 104 and the uplink performance predictor 106.

Input/output operations among the parameter determiner 108, the downlink performance predictor 104, and the uplink performance predictor 106 are repeated until a predetermined condition is satisfied.

Wireless network planning is an operation in which the number of BSs, a location of a BS, and various parameters are determined in a given service area to satisfy a service standard. Wireless network performance is determined according to an efficiency of a wireless network planning, so the wireless network planning is very important.

In exemplary embodiments of the present invention, it will be assumed that parameters used for predicting an uplink performance may include an uplink CINR, an MCS level, an MS transmission power, and a data rate. Hereinafter, the parameters used for predicting the uplink performance will be referred to as an ‘uplink performance prediction index’.

Otherwise, to determine the uplink performance prediction index, a wireless network planning apparatus according to exemplary embodiments of the present invention considers the concepts below.

The wireless network planning apparatus determines the uplink performance prediction index using a minimum required data rate.

The wireless network planning apparatus determines a CINR, an MS transmission power, and a data rate after selecting an MCS level optimized for the MS. If it is impossible that the selected MCS level is allocated to the MS, the wireless network planning apparatus selects other MCS level or determines that it is impossible to provide a service.

The wireless network planning apparatus selects the highest MCS level among MCS levels which the wireless network planning apparatus may allocate in selecting an MCS level.

The wireless network planning apparatus selects one among three cases below in determining the uplink performance prediction index.

Case 1: a maximum achievable CINR

Case 2: a minimum available MS transmission power

Case 3: a maximum achievable data rate

As described above, the uplink performance prediction index is determined based at least partly upon each of the three cases because a trade off relationship is established between an MS transmission power and a data rate. For example, noise power is increased in order to maximize the data rate, thereby decreasing the CINR. So, the determined uplink performance prediction index differs according to which one of the four parameters is used.

Otherwise, an optimized MCS level is predicted for an arbitrary prediction point in a wireless network in an apparatus and method for planning a wireless network according to exemplary embodiments of the present invention. It will be assumed that the prediction point is an MS located in a wireless network, and an uplink CINR, an MS transmission power, and a data rate are determined using the optimized MCS level.

FIG. 2 is a diagram illustrating a structure of a wireless network planning apparatus according to an exemplary embodiment of the present invention.

Referring to FIG. 2, the wireless network planning apparatus includes a parameter input unit 202, a Rise over Thermal (RoT) calculator 204, a first uplink performance prediction index determiner 206, a maximum achievable CINR calculator 208, and a second uplink performance prediction index determiner 210.

The parameter input unit 202 receives parameter information used for planning a wireless network, and outputs the received parameter information to the RoT calculator 204. Here, the received parameter information includes minimum required data rate information, allocable MCS level set information, required CINR information for each MCS level, maximum MS transmission power information, BS coordinate information, antenna information, path loss value information, and so forth.

The RoT calculator 204 calculates an RoT using the received parameter information, and outputs the calculated RoT to the first uplink performance prediction index determiner 206.

The first uplink performance prediction index determiner 206 determines an MCS level after receiving the calculated RoT, and outputs information on the determined MCS level to the maximum achievable CINR calculator 208 and the second uplink performance prediction index determiner 210.

The maximum achievable CINR calculator 208 calculates a maximum achievable CINR using the information on the determined MCS level, and outputs the calculated maximum achievable CINR to the first uplink performance prediction index determiner 206.

The second uplink performance prediction index determiner 210 determines an uplink CINR, an MS transmission power, and a data rate.

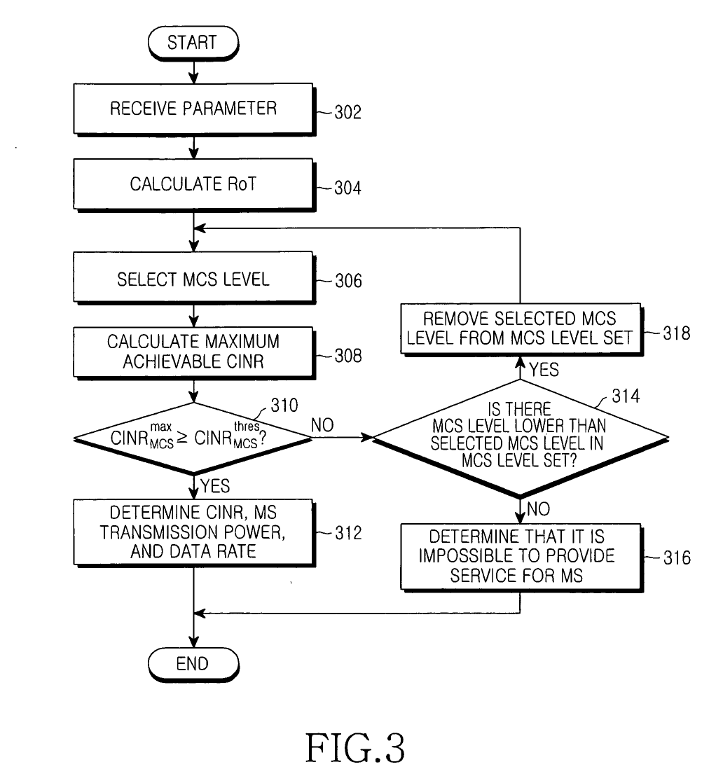

FIG. 3 is a flow chart illustrating a process of determining an uplink performance prediction index of a wireless network planning apparatus according to an exemplary embodiment of the present invention.

Referring to FIG. 3, in step 302, the wireless network planning apparatus receives a parameter. In step 304, the wireless network planning apparatus calculates an RoT. Here, the RoT represents a ratio of a noise power to a sum of an interference received from other cells and the noise power.

In this case, the RoT can be expressed by Equation 1 below:

$$RoT = \frac{N + I}{N} , \qquad [ Eqn . 1 ]$$

where N represents a noise power, and I represents an interference.

When the RoT is determined as expressed in Equation 1, it is possible to calculate a CINR although only one of a noise power and an interference value received from other cell is known. There are two methods of determining the RoT. One is a method using a predetermined value, and the other is a method performing a Monte Carlo Simulation after distributing MSs over a region for planning a wireless network.

In step 306, the wireless network planning apparatus determines at least one of MCS levels allocable to an MS using the calculated RoT, and selects an MCS level which has the highest Modulation order Product coding Rate (MPR) among the determined MCS levels.

Generally, the higher a selected MCS level, the more a bandwidth allocated to an MS is minimized. This is a method for enhancing utilization of limited frequency resources.

In step 308, the wireless network planning apparatus calculates a maximum achievable CINR of the selected MCS level.

In this case, an CINR_{MCS}^{max} as the maximum achievable CINR can be expressed by Equation 2 below:

$$C I N {R}_{MCS}^{max} = \frac{{T}_{max} / L}{I + {N}_{MCS}} , \qquad [ Eqn . 2 ]$$

where L represents a path loss value between an MS and a BS, Tₘₐₓ represents a maximum MS transmission power, and N_{MCS} represents a minimum noise power necessary for satisfying a minimum required data rate of a corresponding MCS level. Here, the L is a calculable value on planning a wireless network, the Tₘₐₓ is a value received in step 302, and the N_{MCS} is determined by multiplying a minimum bandwidth necessary for acquiring a minimum required data rate (Rₘᵢₙ) by a noise power density of a BS.

In step 310, the wireless network planning apparatus compares the CINR_{MCS}^{max} and a CINR_{MCS}^{thres}. Here, the CINR_{MCS}^{thres} represents a required CINR of the MCS level selected in step 306, and the required CINR is a value received in step 302.

If the CINR_{MCS}^{max} is greater than or equal to the CINR_{MCS}^{thres}, the wireless network planning apparatus proceeds to step 312. On the other hand, if the CINR_{MCS}^{max} is less than the CINR_{MCS}^{thres}, the wireless network planning apparatus proceeds to step 314.

In step 314, the wireless network planning apparatus checks whether there is an MCS level lower than the selected MCS level in an MCS level set. As the checking result, if there is not an MCS level lower than the selected MCS level in the MCS level set, the wireless network planning apparatus proceeds to step 316. On the other hand, if there is an MCS level lower than the selected MCS level in the MCS level set, the wireless network planning apparatus proceeds to step 318.

In step 316, the wireless network planning apparatus determines that it is impossible to provide a service for an MS because there is no MCS level allocable to the MS. On the other hand, in step 318, the wireless network planning apparatus removes the selected MCS level from the MCS level set, and returns to step 306.

Otherwise, in step 312, the wireless network planning apparatus determines a currently selected MCS level as an MCS level which is allocated to the MS, and determines a CINR, an MS transmission power, and a data rate. In this case, according to which parameter is preferentially considered, the CINR, the MS transmission power, and the data rate are differently determined.

Next, a method for determining an uplink performance prediction index of each case is described.

Case 1: a maximum achievable CINR

The CINR_{MCS}^{max} calculated in step 308 is a maximum achievable CINR acquirable using a current MCS level, so the CINR_{MCS}^{max} is determined as a CINR of an MS. Further, an MS transmission power is determined as an MS maximum transmission power (Tₘₐₓ), and a data rate is determined as Rₘᵢₙ.

Case 2: a minimum available MS transmission power CINR max

Because the CINR_{MCS}^{max} calculated in step 308 is greater than or equal to a required CINR of a selected MCS level, an MS transmission power may be determined as a value less than Tₘₐₓ. And T_{adj} is defined as an MS transmission power when an adjusted CINR according to a decrease in the MS transmission power is equal to the required CINR, so the CINR_{MCS}^{thres} can be expressed by Equation 3 below:

$$C I N {R}_{MCS}^{thres} = \frac{{T}_{adj} / L}{I + {N}_{MCS}} . \qquad [ Eqn . 3 ]$$

Here, the T_{adj} is determined by arranging Equation 3, and can be expressed by Equation 4 below:

T_{adj}=CINR_{MCS}^{thres}(I+N_{MCS})L. [Eqn. 4]

In this case, a CINR is determined as CINR_{MCS}^{thres}, and a data rate is determined as Rₘᵢₙ. Here, the CINR_{MCS}^{thres} is a required CINR.

Case 3: a maximum achievable data rate

Because the CINR_{MCS}^{max} calculated in step 308 is greater than or equal to a required CINR of a selected MCS level, a data rate may be determined as a value greater than Rₘᵢₙ. An increase in the data rate indicates that the noise power is determined as a value greater than the N_{MCS}. If a data rate acquirable using a currently selected MCS level is a maximum achievable data rate, and the CINR_{MCS}^{max} is greater than a required CINR, an MS transmission power may be determined as a value less than Tₘₐₓ. When it is assumed that a maximum noise power value is Nₘₐₓ, the wireless network planning apparatus checks a condition as expressed by Equation 5 below:

$$C I N {R}_{M C S}^{thres} \leq \frac{{T}_{max} / L}{I + {N}_{max}} . \qquad [ Eqn . 5 ]$$

If CINR_{MCS}^{thres} is less than or equal to

$$\frac{{T}_{max} / L}{I + {N}_{max}} ,$$

an MS transmission power T_{adj} is determined as a value satisfying Equation 6 below. A data rate may be acquired using an MCS level and Nₘₐₓ in Equation 6:

$$C I N {R}_{M C S}^{thres} \leq \frac{{T}_{adj} / L}{I + {N}_{max}} . \qquad [ Eqn . 6 ]$$

However, if CINR_{MCS}^{thres} is greater than

$$\frac{{T}_{max} / L}{I + {N}_{max}}$$

in Equation 5, a data rate is maximum when an MS transmission power is maximum. In this case, N_{adj} may be acquired using Equation 7 below when it is assumed that a noise power is N_{adj}:

$$C I N {R}_{M C S}^{thres} \leq \frac{{T}_{max} / L}{I + {N}_{adj}} . \qquad [ Eqn . 7 ]$$

In Equation 7, a CINR and an MS transmission power is determined as a CINR_{MCS}^{thres} and Tₘₐₓ, respectively, and a data rate is acquired using a selected MCS level and N_{adj}.

Although a description of the present invention is given herein with reference to one prediction point in a wireless network. So, it is preferred that an uplink performance for more than one prediction point is predicted in order to accurately predict an uplink performance in a wireless network.

As is apparent from the foregoing description, according to exemplary embodiments of the present invention, an optimized MCS level is predicted for an arbitrary prediction point in a wireless network. Further, an uplink performance may be accurately predicted by determining an uplink CINR, an MS transmission power, and a data rate using the predicted MCS level.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for planning a wireless network using a self configuration scheme, the apparatus comprising:
a path loss predictor for predicting a path loss between a base station (BS) and a mobile station (MS), and outputting a predicted path loss value;
a downlink performance predictor for predicting a downlink performance using the predicted path loss value, and outputting a predicted downlink performance value;
an uplink performance predictor for predicting an uplink performance using the predicted path loss value, and outputting a predicted uplink performance value; and
a parameter determiner for setting at least one parameter necessary for planning a wireless network using a self configuration scheme using the predicted downlink performance value and the predicted uplink performance value, and determining a value of the set at least one parameter.

2. The apparatus of claim 1, wherein the least one parameter includes at least one among an uplink Carrier to Interference and Noise Ratio (CINR), a Modulation and Coding Scheme (MCS) level, an MS transmission power, and a data rate.

3. The apparatus of claim 1, wherein each of the downlink performance predictor and the uplink performance predictor receives the set at least one parameter and the value of the set at least one parameter.

4. An apparatus for planning a wireless network, the apparatus comprising:
a parameter input unit for receiving parameter information, and outputting the parameter information;
a Rise over Thermal (RoT) calculator for calculating a Rise over Thermal using the parameter information, and outputting the Rise over Thermal;
a first uplink performance prediction index determiner for determining a Modulation and Coding Scheme (MCS) level using the Rise over Thermal, and outputting a determined MCS level information;
a maximum achievable Carrier to Interference and Noise Ratio (CINR) calculator for calculating a maximum achievable Carrier to Interference and Noise Ratio of the determined MCS level using the determined MCS level information, and outputting a calculated maximum achievable Carrier to Interference and Noise Ratio; and
a second uplink performance prediction index determiner for determining at least one among a mobile station (MS) transmission power, a data rate, and an uplink Carrier to Interference and Noise Ratio using the determined MCS level information.

5. The apparatus of claim 4, wherein the parameter information includes at least one among minimum required data rate information, allocable MCS level set information, required CINR information for each MCS level, maximum MS transmission power information, BS coordinate information, antenna information, and path loss value information.

6. The apparatus of claim 4, wherein the RoT calculator calculates a ratio of a noise power to a sum of an interference received from other cells and the noise power.

7. The apparatus of claim 4, wherein the first uplink performance prediction index determiner determines an MCS level which has the highest Modulation order Product coding Rate (MPR) among at least one MCS level allocable to a mobile station using the Rise over Thermal.

8. The apparatus of claim 4, wherein the maximum achievable CINR calculator calculates a maximum achievable Carrier to Interference and Noise Ratio using
$$C I N {R}_{M C S}^{max} = \frac{{T}_{max} / L}{I + {N}_{M C S}} ,$$
where L represents a path loss between a mobile station (MS) and a base station (BS), I represents an interference, Tₘₐₓ represents a maximum MS transmission power, and NMCS represents a minimum noise power necessary for satisfying a minimum required data rate of a corresponding MCS level.

9. The apparatus of claim 4, wherein, when the second uplink performance prediction index determiner preferentially satisfies a maximum achievable Carrier to Interference and Noise Ratio, determines the MS transmission power as a maximum MS transmission power, and determines the data rate as a minimum required data rate.

10. The apparatus of claim 4, wherein, when the second uplink performance prediction index determiner preferentially satisfies a minimum available MS transmission power, determines the uplink Carrier to Interference and Noise Ratio as a required Carrier to Interference and Noise Ratio of the determined MCS level, determines the data rate as a minimum required data rate, and determines the MS transmission power using
T_{adj}=CINR_{MCS}^{tres}(I+N_{MCS})L,
where T_{adj} represents an MS transmission power when an adjusted Carrier to Interference and Noise Ratio according to a decrease in the MS transmission power is equal to a required Carrier to Interference and Noise Ratio, CINR_{MCS}^{thres} represents a required Carrier to Interference and Noise Ratio of the determined MCS level, I represents an interference, N_{MCS} represents a minimum noise power necessary for satisfying a minimum required data rate of a corresponding MCS level and L represents a path loss value between a mobile station (MS) and a base station (BS).

11. The apparatus of claim 4, wherein, when the second uplink performance prediction index determiner preferentially satisfies a maximum achievable data rate,
if a condition
$$C I N {R}_{M C S}^{thres} \leq \frac{{T}_{adj} / L}{I + {N}_{max}}$$
is satisfied, the second uplink performance prediction index determiner determines the uplink CINR as
$$\frac{{T}_{adj} / L}{I + {N}_{max}} ,$$
and determines the MS transmission power (T_{adj}) as T_{adj}=CINR_{MCS}^{thres} (I+N_{MCS})L,
if a condition
$$C I N {R}_{M C S}^{thres} > \frac{{T}_{max} / L}{I + {N}_{max}}$$
is satisfied, the second uplink performance prediction index determiner determines the uplink Carrier to Interference and Noise Ratio as
$$\frac{{T}_{max} / L}{I + {N}_{adj}} ,$$
determines the data rate using the determined MCS level and N_{adj}, and determines the MS transmission power as a maximum MS transmission power (Tₘₐₓ), wherein the CINR_{MCS}^{thres} represents a required Carrier to Interference and Noise Ratio of the determined MCS level, I represents an interference, L represents a path loss between a mobile station (MS) and a base station (BS), Nₘₐₓ represents a maximum noise power value, N_{adj} represents a noise power when an MS transmission power is maximum, N_{MCS} is determined by multiplying a minimum bandwidth necessary for acquiring a minimum required data rate by a noise power density of a base station.

12. A method for planning a wireless network, the method comprising:
receiving parameter information;
calculating a Rise over Thermal (RoT) using the parameter information;
determining a Modulation and Coding Scheme (MCS) level using the calculated Rise over Thermal;
calculating a maximum achievable Carrier to Interference and Noise Ratio (CINR) of the determined MCS level; and
determining at least one among a mobile station (MS) transmission power, a data rate, and an uplink Carrier to Interference and Noise Ratio using the determined MCS level and the calculated maximum achievable Carrier to Interference and Noise Ratio.

13. The method of claim 12, wherein the parameter information includes at least one among minimum required data rate information, allocable MCS level set information, required CINR information for each MCS level, maximum MS transmission power information, BS coordinate information, antenna information, and path loss value information.

14. The method of claim 12, wherein the calculated RoT represents a ratio of a noise power to a sum of an interference received from other cells and the noise power.

15. The method of claim 12, wherein the determined MCS level is an MCS level which has the highest Modulation order Product coding Rate (MPR) among at least one MCS levels allocable to a mobile station according to the calculated RoT.

16. The method of claim 12, wherein the maximum achievable CINR is determined using
$$C I N {R}_{M C S}^{max} = \frac{{T}_{max} / L}{I + {N}_{M C S}} ,$$
where L represents a path loss between a mobile station (MS) and a base station (BS), I represents an interference, Tₘₐₓ represents a maximum MS transmission power, and N_{MCS} represents a minimum noise power necessary for satisfying a minimum required data rate of a corresponding MCS level.

17. The method of claim 12, wherein determining at least one among an MS transmission power, a data rate, and an uplink Carrier to Interference and Noise Ratio using the determined MCS level and the calculated maximum achievable Carrier to Interference and Noise Ratio comprises:
determining the MS transmission power as a maximum MS transmission power in order that the maximum achievable Carrier to Interference and Noise Ratio is preferentially satisfied; and
determining the data rate as a minimum required data rate.

18. The method of claim 12, wherein determining at least one among an MS transmission power, a data rate, and an uplink Carrier to Interference and Noise Ratio using the determined MCS level and the calculated maximum achievable Carrier to Interference and Noise Ratio comprises:
determining the uplink Carrier to Interference and Noise Ratio as a required Carrier to Interference and Noise Ratio of the determined MCS level in order that a minimum available MS transmission power is preferentially satisfied;
determining the data rate as a minimum required data rate;
determining the MS transmission power using
T_{adj}=CINR_{MCS}^{thres}(I+N_{MCS})L,
where T_{adj} represents an MS transmission power when an adjusted Carrier to Interference and Noise Ratio according to a decrease of the MS transmission power is equal to a required Carrier to Interference and Noise Ratio, CINR_{MCS}^{thres} represents a required Carrier to Interference and Noise Ratio of a determined MCS level, I represents an interference, N_{MCS} represents a minimum noise power necessary for satisfying a minimum required data rate of a corresponding MCS level, and L represents a path loss value between a mobile station (MS) and a base station (BS).

19. The method of claim 12, wherein determining at least one among an MS transmission power, a data rate, and an uplink Carrier to Interference and Noise Ratio using the determined MCS level and the calculated maximum achievable Carrier to Interference and Noise Ratio comprises:
in order that a maximum achievable data rate is preferentially satisfied,
if a condition
$$C I N {R}_{M C S}^{thres} \leq \frac{{T}_{max} / L}{I + {N}_{max}}$$
is satisfied, determining the uplink CINR as
$$\frac{{T}_{adj} / L}{I + {N}_{max}} ;$$
determining the data rate using the determined MCS level and Nₘₐₓ; and
determining the MS transmission power (T_{adj}) as T_{adj}=CINR_{MCS}^{thres}(I+N_{MCS})L,
wherein the CINR_{MCS}^{thres} represents a required Carrier to Interference and Noise Ratio of the determined MCS level, Tₘₐₓ represents a maximum MS transmission power, I represents an interference, L represents a path loss value between a mobile station (MS) and a base station (BS), Nₘₐₓ represents a maximum noise power value, and N_{MCS} is determined by multiplying a minimum bandwidth necessary for acquiring a minimum required data rate by a noise power density of a base station.

20. The method of claim 12, wherein determining at least one among an MS transmission power, a data rate, and an uplink Carrier to Interference and Noise Ratio using the determined MCS level and the calculated maximum achievable Carrier to Interference and Noise Ratio comprises:
in order that a maximum achievable data rate is preferentially satisfied,
if a condition
$$C I N {R}_{M C S}^{thres} > \frac{{T}_{max} / L}{I + {N}_{max}}$$
is satisfied, determining the uplink CINR as
$$\frac{{T}_{max} / L}{I + {N}_{adj}} ;$$
determining the data rate using the determined MCS level and N_{adj}; and
determining the MS transmission power as a maximum MS transmission power (Tₘₐₓ),
wherein the CINR_{MCS}^{thres} represents a required CINR of the determined MCS level, I represents an interference, L represents a path loss value between a mobile station (MS) and a base station (BS), Nₘₐₓ represents a maximum noise power value, N_{adj} represents a noise power when an MS transmission power is maximum.

21. A method for planning a wireless network by predicting an uplink performance of an arbitrary prediction point in the wireless network, the method comprising:
receiving performance prediction parameter information;
selecting a Modulation and Coding Scheme (MCS) level which has the highest Modulation order Product coding Rate (MPR) among MCS levels supportable by the arbitrary prediction point;
calculating a maximum Carrier to Interference and Noise Ratio (CINR) of the selected MCS level using the received performance prediction parameter information;
determining a Carrier to Interference and Noise Ratio of the arbitrary prediction point as one of the calculated maximum Carrier to Interference and Noise Ratio and a required Carrier to Interference and Noise Ratio of the selected MCS level when the calculated maximum Carrier to Interference and Noise Ratio is greater than or equal to the required Carrier to Interference and Noise Ratio of the selected MCS level; and
predicting a transmission power and a data rate of the arbitrary prediction point using the determined Carrier to Interference and Noise Ratio.

22. The method of claim 21, wherein the received performance prediction parameter information includes at least one among minimum required data rate information, allocable MCS level set information, required CINR information for each MCS level, maximum MS transmission power information, BS coordinate information, antenna information, and path loss value information.

23. The method of claim 21, further comprising:
calculating a Rise over Thermal (RoT) using the received performance prediction parameter information; and
determining at least one MCS level using the calculated Rise over Thermal.
